(19) United States
(12) Patent Application Publication
(10) Pub. No.: US 2018/0255777 A1
(43) Pub. Date: Sep. 13, 2018

(54) Metal Ion Complex-Modified Layered Silicates

(71) Applicants: Phumelele Kleyi, Pretoria (ZA); Arjun Maity, Pretoria (ZA); Suprakas Sinha Ray, Pretoria (ZA)

(72) Inventors: Phumelele Kleyi, Pretoria (ZA); Arjun Maity, Pretoria (ZA); Suprakas Sinha Ray, Pretoria (ZA)

(21) Appl. No.: 15/916,840

(22) Filed: Mar. 9, 2018

(30) Foreign Application Priority Data
Mar. 9, 2017 (ZA) 2017/01702

(51) Int. Cl. A01N 43/50; A01N 25/08; C02F 1/50

(52) U.S. Cl. CPC A01N 43/50; A01N 25/08; C02F 2103/007; C02F 2303/04; C02F 1/505

(57) ABSTRACT

A layered silicate modified with a metal ion N-heterocyclic complex is provided. The N-heterocyclic ligand of the metal ion N-heterocyclic complex is N-alkyl substituted or alkylated at positions 2-, 4- or 5- of the N-heterocyclic ring. The modified layered silicate is useful in treating water to disinfect the water.

### RELATED APPLICATION

This application claims the benefit of priority to South Africa patent application serial number 2017/01702, filed Mar. 9, 2017.

### FIELD OF THE INVENTION

THIS INVENTION relates to metal ion complex-modified layered silicates. In particular, the invention relates to layered silicate modified with a metal ion N-heterocyclic complex, and to a method of treating water.

### BACKGROUND OF THE INVENTION

According to a WHO Joint Monitoring Programme report, at the time of filing of the priority patent application for this invention about 91% of the global population had access to clean drinking water sources. This success can be mainly attributed to the availability of clean municipal water supply and household water treatment technologies. However, the report also reveals that 663 million people, globally, still remain without safe water sources (springs, unprotected wells and surface water), and 50% of this population lives in sub-Saharan Africa.

The use of household treatment technologies provides end-users with full control over the quality of water they consume and consequently assists with the reduction of waterborne diseases. Thus, the necessity to escalate research efforts for the development of household water treatment technologies cannot be overstated. In addition, in municipal water treatment plants, filtration to remove microorganisms is typically effected using filtration media with no antimicrobial properties, requiring the use of a chlorination step to ensure that bacteria that survive filtration are inactivated. Residual chlorine in the drinking water may result in carcinogenic by-products and unpalatable water and technologies that can reduce this risk are thus desirable.

Household water disinfection technologies that already exist include chlorinators, flocculators, solar disinfectants, and slow sand and ceramic filters. Ceramic water filters have been favoured devices for the disinfection of water due to their affordability, portability and user-friendliness. These filters are made from fired clay and are microporous which enables the removal of microorganisms (e.g., bacteria, protozoa). However, the filters cannot inactivate (kill) the trapped microorganisms and this could lead to replication (i.e. growth) of the microorganisms. Replication of microorganisms could be detrimental to filter efficiency and consequently increases the risk to human health.

This challenge is usually circumvented by coating or impregnating the ceramic filter with colloidal silver (i.e. silver nanoparticles also known as AgNPs) effectively to inactivate the microorganisms. The use of silver as a water disinfectant dates back many centuries when humans placed silver coins in water storage vessels or stored water in silver containers to prevent growth of bacteria. While metallic silver (Ag⁰) has no known antimicrobial properties, its ionic form (Ag⁺) has excellent antimicrobial properties. The implication is that Ag⁺ must leach from ceramic filters to come into contact with microorganisms for inactivation to occur, thus posing a risk to human health and deterioration of filter efficacy over time.

There is thus a need for filtration media that include antimicrobial or disinfecting agents that are less prone to leaching from the media, for treating water.

### SUMMARY OF THE INVENTION

A layered silicate modified with a metal ion N-heterocyclic complex is provided. The N-heterocyclic ligand of the metal ion N-heterocyclic complex is N-alkyl substituted or alkylated at positions 2-, 4- or 5- of the N-heterocyclic ring. The modified layered silicate is useful in treating water to disinfect the water.

### BRIEF DESCRIPTION OF THE DRAWINGS

FIG. 1 shows a comparison of FTIR spectra of montmorillonite (CNa), silver(I)-N-octylimidazole complex (Ag(octIm)₂) and silver(I)-N-alkylimidazole-modified montmorillonite CNa—Ag(octIm)₂.

FIG. 2 shows XRD patterns of CNa and CNa—Ag(octIm)₂.

FIG. 3 shows thermal stability profiles of (a) Ag(octIm)₂, and (b) unmodified CNa, and CNa—Ag(octIm)₂.

FIG. 4 shows TEM micrographs of (a) CNa, (b) and (c) CNa—Ag(octIm)₂ and (d) EDX spectrum of CNa—Ag(octIm)₂.

FIG. 5A shows a widescan high resolution XPS spectra of CNa—Ag(octIm)₂.

FIG. 5B shows the Ag 3d binding energy region of a high resolution XPS spectrum of CNa—Ag(octIm)₂.

FIG. 6 shows agar plates with results for disinfection of contaminated river water using CNa—Ag(octIm)₂; cultures are of (a) V. cholerae, (b) S. dysenteriae, (c) S. enteriditis, (d) B. subtilis, (e) control for B. subtilis and (f) B. subtilis using CNa—AgNPs.

FIG. 7 shows photographs of (a) leaching from CNa—AgNPs and (b) no leaching from CNa—Ag(octIm)₂.

FIG. 8 shows UV-vis spectra for the investigation of leaching of Ag⁺ ions from CNa—Ag(octIm)₂.

FIG. 9 shows TEM micrographs illustrating the inactivation mechanism of CNa—Ag(octIm)₂ against S. enteriditis and B. subtilis: (a) S. enteriditis (control), (b) & (c) S. enteriditis treated with CNa—Ag(octIm)₂, (d) B. subtilis (control), (e) & (f) B. subtilis treated with CNa—Ag(octIm)₂.

### DETAILED DESCRIPTION OF THE INVENTION

According to one aspect of the invention, there is provided a layered silicate modified with a metal ion N-heterocyclic complex, the N-heterocyclic ligand of the metal ion N-heterocyclic complex being N-alkyl substituted or alkylated at positions 2-, 4- or 5- of the N-heterocyclic ring.

In the modified layered silicate, the metal ion N-heterocyclic complex is intercalated in the interlayer spaces of the layered silicate, i.e. is incorporated in the clay matrix.

The metal ion may be Ag⁺, Cu²⁺ or Zn²⁺.

In a preferred embodiment of the invention, the metal ion is Ag⁺.

The N-heterocyclic ligand may be selected from the group consisting of imidazoles and triazoles.

In a preferred embodiment of the invention, the N-heterocyclic ligand is imidazole.

The substitution of the hydrogen atom on the nitrogen atom of the N-heterocyclic ligand may be with a hydrophobic substituent, e.g. an alkyl chain.

The alkyl chain may be selected from the group consisting of octyl, decyl, dodecyl, tetradecyl and hexadecyl.

In one embodiment of the invention, the alkyl chain is the 8-carbon hydrocarbon (octyl).

The layered silicate, i.e. clay material or nanoclay, may be a negatively charged layered silicate.

The layered silicate may be selected from the group consisting of montmorillonite, bentonite, beidellite, saponite and notronite.

In one embodiment of the invention, the layered silicate is montmorillonite.

The modified layered silicate (i.e. a modified nanoclay) may be in particulate form.

The modified layered silicate may have a particle size distribution such that it has a D90 value of no more than about 500 μm, preferably no more than about 400 μm, more preferably no more than about 350 μm, most preferably no more than about 300 μm, e.g. about 250 μm.

Typically, the modified layered silicate has a particle size distribution such that it has a D10 value of at least about 50 μm.

The quantity of metal ion N-heterocyclic complex in the modified layered silicate may be at least about 25% of the cation exchange capacity (CEC) of the layered silicate, preferably at least about 50% CEC, e.g. 50% CEC or 75% CEC or 100% CEC.

The modified layered silicate may include metal nanoparticles, e.g. silver nanoparticles. The metal nanoparticles may be capped by an N-alkyl substituted heterocyclic ligand, e.g. an N-alkylimidazole. Typically, the metal nanoparticles are not intercalated in the interlayer space of the modified layered silicate.

According to another aspect of the invention, there is provided a method of treating water to disinfect the water, the method including contacting the water with a layered silicate modified with a metal ion N-heterocyclic complex, wherein the N-heterocyclic ligand of the metal ion N-heterocyclic complex is N-alkyl substituted or alkylated at positions 2-, 4- or 5- of the N-heterocyclic ring and wherein the metal ion has antimicrobial or disinfectant properties.

The modified layered silicate may be as hereinbefore described.

The water may include pathogenic Gram negative and/or Gram positive bacteria.

In one embodiment of the method of the invention, the water is disinfected from pathogenic Gram negative bacteria selected from the group consisting of Salmonella enteriditis, Shigella dysenteriae and Vibrio cholerae.

In another embodiment of the method of the invention, the water is disinfected from the pathogenic Gram positive bacteria Bacillus subtilis.

The following experimental study, and the accompanying drawings, further describe embodiments of the invention.

Experimental Study

An experimental study was done on the preparation of silver(I)-N-alkylimidazole-modified montmorillonite. The disinfection properties of silver(I)-N-alkylimidazole-modified montmorillonite for river water was also determined. The silver(I) complex was synthesized by the reaction of silver nitrate and N-alkylimidazole whereafter the silver complex was used for the modification of montmorillonite. Characterization of the silver complex was performed using IR and its intercalation in the interlayer space of montmorillonite was ascertained using XRD as well as TEM techniques while thermal stability was investigated with TGA. The modified montmorillonite was investigated for disinfection of river water contaminated with Gram-negative and Gram-positive bacteria. Details of the experimental study are set out hereinafter.

Materials

Silver nitrate (AgNO₃), imidazole and various alkylbromides were purchased from Merck Chemicals (Johannesburg, South Africa). Montmorillonite [Cloisite®Na (CNa); cation exchange capacity (CEC)=92.6 meq/100 g] was purchased from Southern Clay Products, Inc. (Texas, USA). Escherichia coli (ATCC® 25922), Bacillus subtilis (ATCC® 11774), Salmonella enteriditis (ATCC® 13076), Shigella dysenteriae (ATCC® 13313) and Vibrio cholerae (NCTC® 5941), were obtained from Quantum Biotechnologies (Randburg, South Africa). River water was collected from the Apies River in Pretoria, South Africa.

Methods

Synthesis of N-Alkylimidazoles

N-alkylimidazoles were synthesized using a previously reported method with minor modification. Typically, to a solution of imidazole (1 mol equiv.) and sodium hydroxide (1 mol equiv.) in acetone (50 mL) was added 1-bromoalkane (0.8 mol equiv.). After stirring at room temperature for 12 h, a NaBr precipitate was filtered and acetone removed under reduced pressure. A residual oily mass was re-dissolved in dichloromethane and extracted three times with water. Finally, an organic phase was dried on anhydrous sodium sulfate and dicholoromethane was removed under reduced pressure to produce brown oil.

Synthesis of Silver(I)-N-Alkylimidazole Complexes

Silver(I)-N-octylimidazole complexes were also synthesized using a previously reported method with a minor modification. Typically, N-octylimidazole (2 mol equiv.) was added to a solution of AgNO₃ (1 mol equiv.) in ethanol (15 mL) and the reaction mixture was stirred at room temperature for 24 h. The reaction mixture was filtered and evaporation of the solvent mixture gave a brown oil or cream solid. The brown oil was re-dissolved in dichloromethane and extracted three times with water. The organic phase was dried on anhydrous sodium sulfate and the solvent was removed under reduced pressure. Other silver(I)-N-alkylimidazole complexes were synthesized in the same manner. The solid complexes were further purified by recrystallization by dissolving in dichloromethane and precipitated with hexane.

Modification of Montmorillonite with N-Alkylimidazole Complex

Montmorillonite (20 g) was fully dispersed by vigorously stirring in deionized water (600 mL) for 4 h. An ethanol solution (250 mL) containing an appropriate mass of the surfactant (silver(I)-N-alkylimidazole complex), calculated based on the CEC of montmorillonite (92.6 meq/100 g), was added to the dispersed montmorillonite. The mixture was continuously stirred overnight for 12 h, and the silver(I) complex-modified montmorillonite was filtered under suction, washed several times with a (50:50 v/v) ethanol/water mixture and dried in an oven at 100° C. It was then ground to pass through a 250 μm sieve and stored in a closed container.

An alternative, shortened and less costly method used for the modification of montmorillonite with the N-alkylimidazole complex was as follows: To a solution of AgNO₃ (1.101 g) in ethanol/water (60:40 v/v) was added N-octylimidazole (2.342 g). After stirring for 1 h, bentonite 50 meq/100 g) was added to the reaction mixture. The mixture was continuously stirred for a further 2 h, and the silver(I) complex-modified montmorillonite was filtered under suction, washed several times with a (50:50 v/v) ethanol/water mixture and dried in an oven at 100 ° C. It was then ground to pass through a 250 μm sieve and stored in a closed container.

Microbiological Assays

Disk Diffusion Method

Working solutions were prepared by dissolving of N-alkylimidazoles (100 mg) in ethanol (50 μL). Blank disks were impregnated with 10 μL of solution and the disks placed on nutrient agar containing a confluent E. coli culture. The plates were incubated at 37° C. for 18-24 h and antimicrobial activity determined by measuring the zone of inhibition. The experiments were performed in triplicate.

Disinfection Properties of Modified Montmorillonite

Silver(I)-N-alkylimidazole-modified montmorillonite (20 mg) was placed in Falcon™ tubes containing sterile river water (20 mL). The tubes were inoculated with E. coli to a final concentration of approximately 10⁷ CFU/mL. Samples were collected after inoculation at 1 min intervals for 10 min. Bacterial concentrations in the samples were analyzed using the drop plate technique on nutrient agar. For B. subtilis, a spread plate technique on nutrient agar was used. Tubes containing the bacteria without the modified montmorillonite were used as controls. The experiments were performed in triplicate.

Leaching Experiments

A weighed sample of montmorillonite modified with silver(I)-N-octylimidazole (hereinafter sometimes referred to as CNa—Ag(octIm)₂) (250 mg) was placed in deionised water (10 mL) in a Falcon™ tube. The solution was analysed using UV-vis spectroscopy at 1 h intervals up to 4 h, and was sporadically analysed up to 3 months. The presence or absence of Ag⁺ ions was further investigated by treating samples with dilute HCl (0.1 M).

Characterization

IR spectra were obtained on a Perkin Elmer Spectrum 100 Attenuated Total Reflectance (ATR) FTIR (USA) spectrometer from 4000-500 cm⁻¹ using 16 scans and a resolution of 4 cm⁻¹. Thermal analysis was carried out on a TA Q500 TGA Instrument (USA) in an air environment. XRD experiments of pure and organically modified CNa were performed on a PANalytical X'Pert PRO diffractometer (Netherlands) with CuKα (λ=1.5406 Å) radiation at 40 mA and 45 kV. Scans were recorded between 2ϑ=0° and 40° with a step size of 0.02° and a scan speed of 2°/min. TEM study of biological samples was performed on a JEOL JEM-2100 Electron Microscope (Japan) at an accelerated voltage of 200 kV.

Results

Synthesis and Characterization of Silver(I)-N-Alkylimidazole Complexes

As mentioned hereinbefore, the synthesis of silver(I)-N-alkylimidazole complexes was performed by first preparing the precursor ligands (N-alkylimidazoles with various alkyl chains), using a previously reported method. The subsequent reaction of N-alkylimidazoles and AgNO₃ in ethanol gave the target complexes according to the scheme shown below.

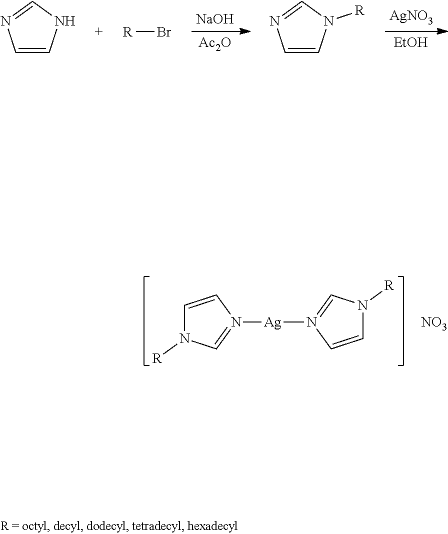

The structure of the silver(I)-N-alkylimidazole complexes has been elucidated previously using the single crystal XRD technique.

Antibacterial Activity Evaluation of Silver(I)-N-Alkylimidazole Complexes

The antibacterial activity of N-alkylimidazoles was investigated by the disk diffusion and broth methods against E. coli as a model microorganism. The results of the in vitro antibacterial activity experiments are shown in Table 1.

TABLE 1
Zone of inhibition diameters for silver(I)-N-alkylimidazole complexes

| Carbon chain | Compound | Zone of inhibition |
|---|---|---|
| length (R) | code | diameter (mm) |
| 8 | Ag(octlm)₂ | 21 ± 1.4 |
| 10 | Ag(declm)₂ | 16 ± 1.4 |
| 12 | Ag(dodeclm)₂ | 12.5 ± 2.1 |
| 14 | Ag(tetradeclm)₂ | 13 ± 2.8 |
| 16 | Ag(hexadeclm)₂ | 7.5 ± 0.7 |

It can clearly be seen that the activity increased as the alkyl chain length decreased, from hexadecyl to octyl, with Ag(octIm)₂ displaying superior activity while Ag(hexadeclm)₂ exhibited the poorest activity. Interestingly, similar silver(I) complexes containing 2-hydroxymethyl-N-alkylimidazole ligands were reported to exhibit poor antibacterial activity against E. coli. The result in this study clearly showed the effect that the substituents, on the imidazole moiety, have on the antimicrobial properties. Essentially, the N-alkylimidazole ligands used in this study have no substituent at the 2 position, which could be the reason for the activity displayed against E. coli. The broth experiments also showed similar results (data not shown) as observed in the disk diffusion method. Since it displayed excellent antibacterial properties, the silver complex Ag(octIm)₂ was chosen for the modification of montmorillonite for river water disinfection. Accordingly, the characterization and experimental data discussed hereinafter is for montmorillonite modified with Ag(octIm)₂, i.e. CNa—Ag(octIm)₂.

Characterization of Modified Montmorillonite

FTIR Spectroscopy

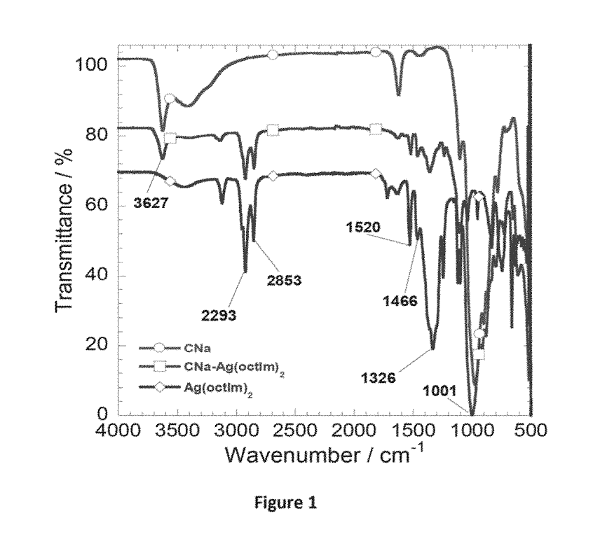

FIG. 1 illustrates the comparison between FTIR spectra of unmodified montmorillonite (CNa), Ag(octIm)₂ and CNa—Ag(octIm)₂. The spectrum of silver(I)-complex-modified montmorillonite [CNa—Ag(octIm)₂] displayed a signal at 3627 cm⁻¹ which corresponded with the signal observed in the spectrum of montmorillonite. This peak was due to the OH stretching frequency [v(OH)] in unmodified montmorillonite. Another signal at 1001 cm⁻¹ indicating the presence of Si—O—Si stretching frequency [v(Si—O—Si)] also corresponded with the spectrum of CNa. The disappearance of the broad signal at ˜3400 [stretching frequency v(H₂O)] and 1600 cm⁻¹ [deformation frequency δ(H₂O)], originally present in the spectrum of unmodified montmorillonite, indicated the loss of interlayer water in CNa—Ag(octIm)₂. The signals that appeared at 2923 (vₐₛ(CH₂)) and 2853 cm⁻¹ (vₛ(CH₂)) as well as at 1520 and 1458 cm⁻¹ (v(C═C), v(N═C—C)) were indicative of the alkyl chain and the imidazole moiety. The conspicuous disappearance of the signal at 1326 cm⁻¹, due to NO₃⁻ ions, indicated the interaction of the negative clay surface and the cationic silver(I) complex. The data obtained from the spectra confirmed that the silver(I)-N-alkylimidazole complex was successfully incorporated in the montmorillonite matrix.

XRD Analysis

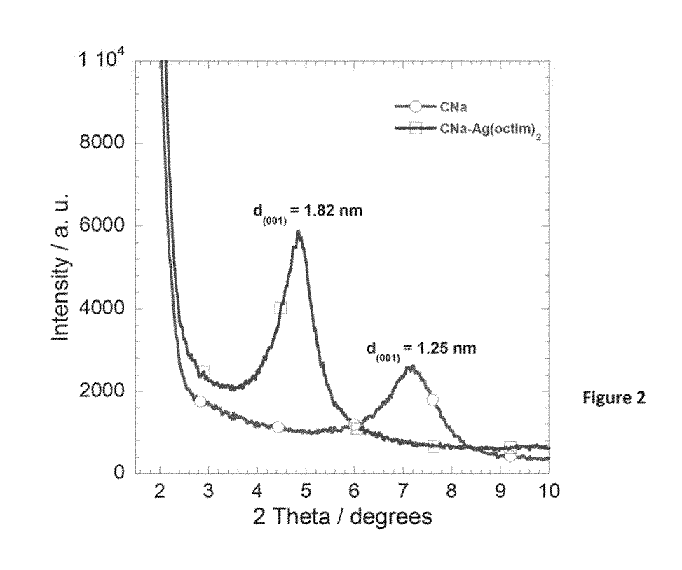

XRD analysis was used to investigate the intercalation of Ag(octIm)₂ into the silicate layers of unmodified montmorillonite (CNa). As depicted in FIG. 2, the X-ray diffractogram for unmodified montmorillonite exhibited a (001) diffraction with basal spacing of 1.25 nm at 2ϑ=7.06°, a characteristic of well-oriented material with a monolayer hydrated type structure. The diffraction angle 2ϑshifted from 7.06° (d₍₀₀₁₎=1.25 nm) for the unmodified montmorillonite to 4.85° (d₍₀₀₁₎=1.82 nm) for silver(I) complex-modified montmorillonite (CNa—Ag(octIm)₂). The increase in the d-spacing in CNa—Ag(octIm)₂ indicated successful intercalation of Ag(octIm)₂ in the interlayer space of montmorillonite. Moreover, the sharpness of the (001) diffraction peak of CNa—Ag(octIm)₂ and the planar configuration of the Ag(octIm)₂ suggested a parallel oriented structure.

Thermogravimetric Analysis

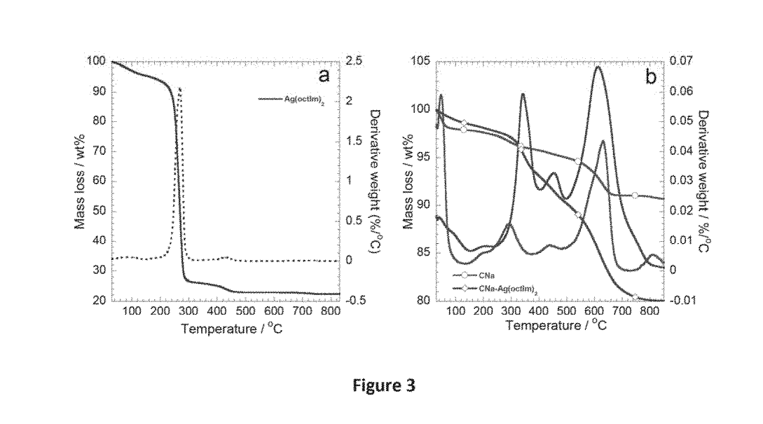

The thermal stability of CNa—Ag(octIm)₂ was investigated using TGA and compared with that of unmodified montmorillonite (CNa) and Ag(octIm)₂. The thermal stability profiles of unmodified montmorillonite, Ag(octIm)₂ and CNa—Ag(octIm)₂ are depicted in FIGS. 3a and 3b. The thermogram of Ag(octIm)₂ (FIG. 3a) revealed a two-step decomposition pathway, with a large mass loss (68%) at 268° C. as well as a small mass loss (2%) at 428° C. The mass loss at 268° C. was attributed to the decomposition of Ag(octIm)₂, while that at 428° C. was attributed to evolution of carbon dioxide (decomposition of N-alkylimidazole moiety) leaving stable residual oxide(s) of silver. The small mass loss below 100° C. was assigned to evaporation of water since silver(I)-N-alkylimidazole complexes with shorter alkyl chains are liquid-like (ionic liquids) and slightly hygroscopic.

The thermogram of CNa-(octIm)₂ displayed an insignificant mass loss below 100° C. which corresponded to the signal attributed to loss of surface-adsorbed water in unmodified montmorillonite (FIG. 3b). Another small mass loss was observed at approximately 200° C. and was assigned to the loss of residual interlayer water. The subsequent decomposition of CNa-(octIm)₂ occurred via three distinct mass loss events. A mass loss signal (5%) was observed at 342° C. which was attributed to the oxidative decomposition of the ligand (octIm₂) coordinated to Ag⁺. The second mass loss signal (2%) at 456° C. was attributed to the loss of CO₂ while the last signal (12%) observed at 614° C. was assigned to loss of structural water (dehydroxylation).

TEM Observations

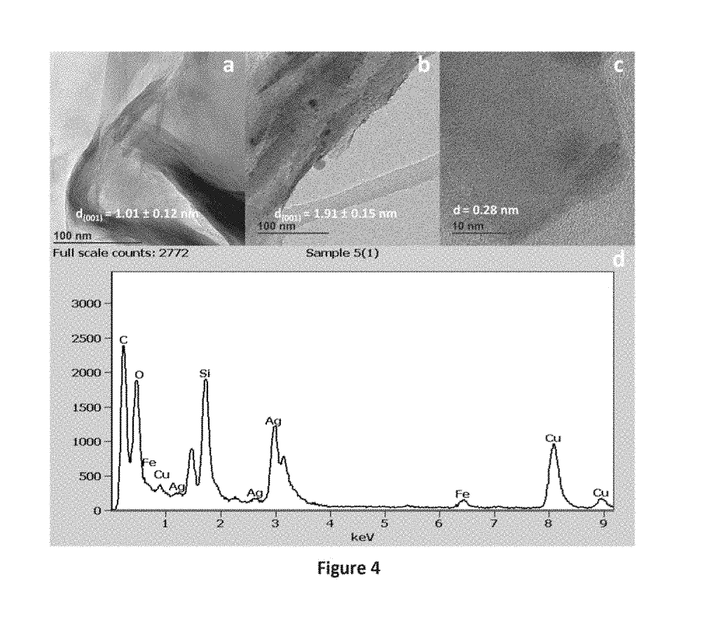

Further characterization using TEM and EDX showed that Ag(octIm)₂ was intercalated in the interlayer space of montmorillonite (FIG. 4a-d). The measured d-spacing value for CNa—Ag(octIm)₂ was 1.91±0.15 nm which was in good agreement with XRD data. However, the value obtained with TEM analysis was slightly larger (by ˜1 nm) due to inherent software measurement errors measuring on the micrographs. Not surprisingly, it was observed that AgNPs (size=19.6±5.5 nm, d₍₀₀₁₎=0.2804 nm) were also present (FIGS. 4b & c) and were the result of the reduction of Ag⁺ in Ag(octIm)₂ in the presence of ethanol. Ethanol was used to dissolve the silver-N-alkylimidazole complexes due to their lack of solubility in water. It was anticipated that the observed AgNPs were capped (stabilized) by the N-alkylimidazole ligand (octylimidazole). The implication was that the capped nanoparticles would have hydrophobic surfaces (due to alkyl chains) and hence decrease the likelihood that it could leach.

The interlayer space of montmorillonite (and palygorskite) modified with AgNO₃ can be intercalated by both Ag⁺ as well as AgNPs (Ag(0)). In this study, it was not immediately clear whether Ag(octIm)₂ was intercalated exclusively in the interlayer space of montmorillonite or both the capped AgNPs and Ag(octIm)₂ were intercalated. However, the average size of the AgNPs (19.6±5.5 nm) suggested that they existed outside of the interlayer space (1.91±0.15 nm). Therefore, this presence of AgNPs was further investigated using XPS analysis.

XPS Analysis

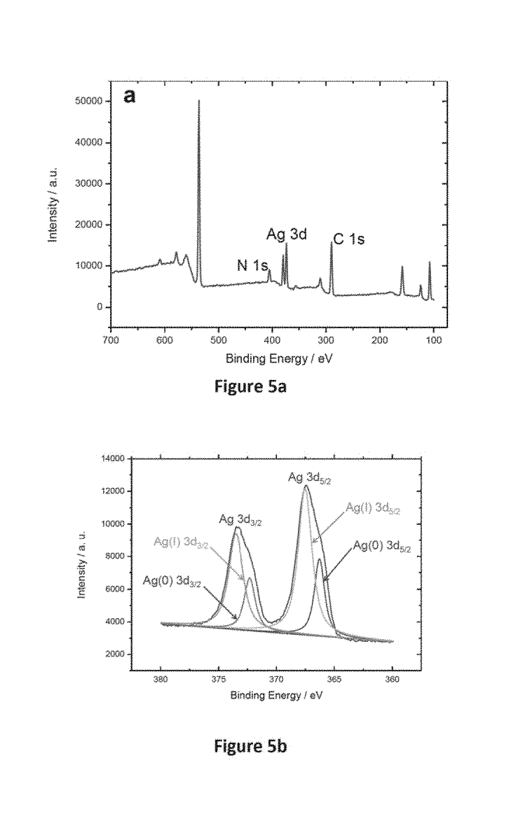

The widescan XPS spectrum of CNa—Ag(octIm)₂ displayed signals at 283 eV (C 1s), 399 eV (N 1s) as well as at 360-380 eV (Ag 3d) binding energies (FIG. 5a). These signals confirmed the presence of both the N-octylimidazole (C 1s and N 1s) and silver (Ag 3d) moieties. The Ag 3d binding energy region was further split into two signals; at 367 and 373 eV for Ag 3d_{5/2} and Ag 3d_{3/2}, respectively, with a spin-orbit splitting (A) of 6 eV (FIG. 5b). The signals also appeared to be asymmetrical due to the shoulder on the right side, indicating the presence of another overlapping signal. Deconvolution of the signals (Ag 3d_{5/2} and Ag 3d_{3/2}) revealed that each signal comprised two signals at 366 and 367 eV for Ag 3d_{5/2}, and at 372 and 373 for Ag 3D_{3/2}. The signals at 366 and 372 eV represented the Ag 3d_{5/2} and Ag 3d_{3/2} binding energies for Ag(0), the AgNPs. Moreover, the signals at 367 and 373 eV respectively denoted the Ag 3d_{5/2} and Ag 3d_{3/2} for Ag(I). The assignment of the binding energies for Ag(0) and Ag(I) was done based on the knowledge that electron-rich atoms have low binding energies for the core electrons and vice versa. Thus, it was concluded that the AgNPs were present in the montmorillonite (CNa) matrix, however, they may not be intercalated in the interlayer space of montmorillonite due to the average particle size.

Microbiological Assays

Evaluation of Disinfection Properties of CNa—Ag(octIm)₂

Initial experiments involved the optimization of the quantity of Ag(octIm)₂ using different montmorillonite-based materials synthesised by modification of montmorillonite at 4 levels (25, 50, 75, 100% CEC) as well as the mass of selected modified montmorillonite. Although the data is not shown, it was observed that 50, 75 and 100% CEC modified montmorillonite displayed excellent disinfection properties. Therefore, CNa—Ag(octIm)₂ [50% CEC] was selected to further optimize the quantity of material, and the optimized mass was 20 mg.

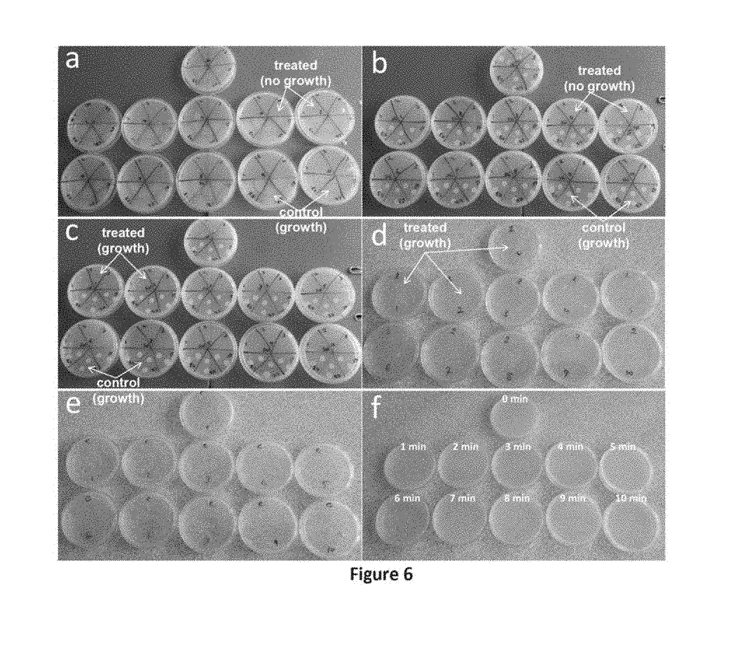

The selected modified montmorillonite was evaluated for disinfection of river water contaminated with pathogenic Gram negative (Salmonella enteriditis, Shigella dysenteriae and Vibrio cholerae) and Gram positive (Bacillus subtilis) bacteria. The river water was first sterilized and then inoculated with appropriate microorganism. The main goal was to determine the scope of the spectrum of disinfection properties and the kinetics of disinfection for CNa—Ag(octIm)₂. FIG. 6 illustrates the results for disinfection of river water contaminated with pathogenic bacteria using CNa—Ag(octIm)₂. Times for all the petri dishes are as illustrated in FIG. 6(f). It was observed that CNa—Ag(octIm)₂ displayed excellent disinfection properties for river water contaminated with all the bacteria used in the experiments. It was also observed that the Gram negative bacteria were more susceptible to inactivation by CNa—Ag(octIm)₂ than the Gram positive bacteria.

River water contaminated with V. cholerae showed no growth even at time t=0 min (FIG. 6a) while river water contaminated with S. dysenteriae showed no growth at time t=1 min (FIG. 6b) after treatment with CNa—Ag(octIm)₂. Furthermore, river water contaminated with S. enteriditis displayed no growth at time t=5 min (FIG. 6c) and thus took longer to disinfect than the river water contaminated with the other two Gram negative bacteria. For the river water contaminated with Gram positive bacteria (B. subtilis), there was significant growth until time t=2 min and the bacteria persisted but with significantly reduced growth until time t=10 min (FIG. 6d). This result indicated that more than 10 minutes would be required for disinfection of water contaminated with B. subtilis using CNa—Ag(octIm)₂ since only few live bacteria remained after contact time t=10 min.

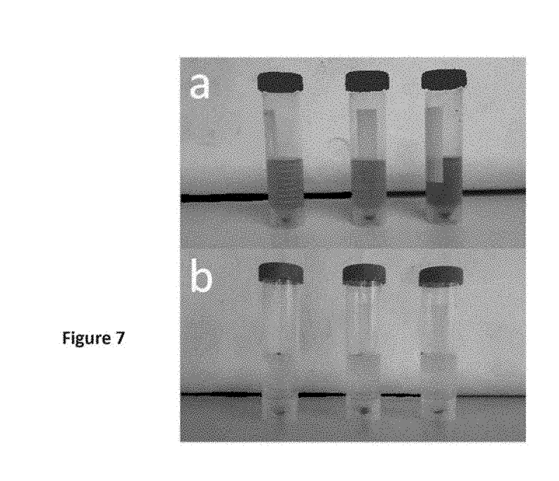

Comparison between river water contaminated with B. subtilis treated with CNa—Ag(octIm)₂ and that treated with silver nitrate modified montmorillonite (CNa—AgNPs) revealed that CNa—AgNPs performed better than CNa—Ag(octIm)₂ as no growth was observed in all the petri dishes. As illustrated in FIG. 7, this result was attributed to the observed leaching of Ag⁺ ions from CNa—AgNPs which was not observed from CNa—Ag(octIm)₂. The quantity of Ag⁺ ions leached from 20 mg of CNa—AgNPs in 20 mL of deionised water was determine using ICP-MS, and was found to be 1.83±0.53 ppm. It was deduced from this observation that CNa—Ag(octIm)₂ would be the preferred choice, over CNa—AgNPs, for disinfection of drinking water since the risk to human health as a result of leaching would apparently be completely eliminated. Moreover, despite not visually observing the leaching of Ag⁺ ions from CNa—Ag(octIm)₂, it was further investigated. It is worth to note that this material exhibited superior disinfection kinetics compared to silica-based material reported in literature.

Leaching Experiments

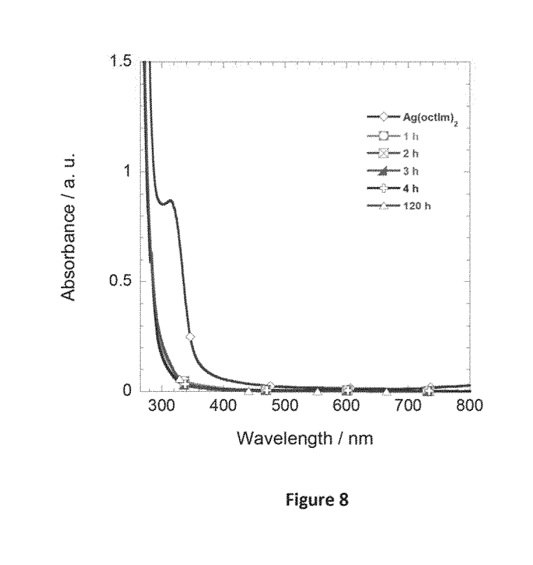

Leaching of the Ag⁺ ions from the modified CNa (CNa—Ag(octIm)₂) could pose serious challenges; not only would it be difficult to attribute the disinfection properties to CNa—Ag(octIm)₂, but it would have adverse health effects to humans as well. Thus, leaching of Ag⁺ions from CNa—Ag(octIm)₂ was investigated using UV-vis spectroscopy and gravimetrically by precipitation of Ag⁺ ions with a dilute HCl solution. FIG. 8 illustrates the UV-vis spectra for the leaching experiments. The spectrum of Ag(octIm)₂ displayed an absorption band at λₘₐₓ=314 nm, which represented π→π* transitions. The spectrum also exhibited a long tail of absorption that began at λₘₐₓ˜500 nm and extended to the onset of the previous absorption band (λₘₐₓ=314 nm) at λ=360 nm which was attributed to metal-to-ligand charge transfer (MLTC) band. Silver(I)-imidazole complexes usually exhibit a weak and broad absorption band in the wavelength range λ=400-500 nm due to MLCT band.

The spectra of the samples did not exhibit any similar absorption bands to those observed on Ag(octIm)₂ spectrum, an indication that there was no leaching of the Ag⁺ ions. To further confirm this observation, dilute HCl solution was added to the samples. The formation of a white precipitate (AgCl) would indicate the presence of Ag⁺ ions and vice versa. However, the addition of dilute HCl to the samples did not produce any white precipitate and thus confirmed that no leaching occurred.

Mechanism of Inactivation by Modified CNa

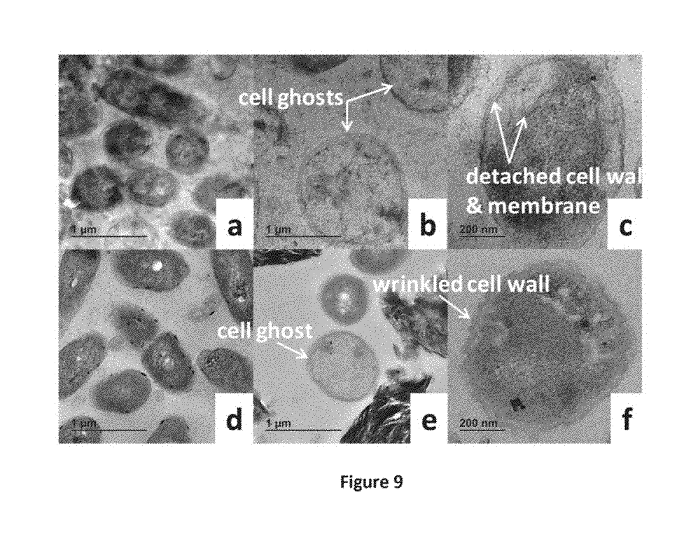

The mechanism of inactivation of silver(I) complex-modified montmorillonite (CNa—Ag(octIm)₂) was investigated against S. enteriditis and B. subtilis using TEM. These were the two bacteria that took slightly longer to be inactivated and FIG. 9 illustrates the TEM micrographs displaying the mechanism of inactivation. Previous studies have reported that the action of immobilized AgNPs occurs through physical contact with the material and/or leaching of the silver ions. However, since no leaching was observed, in the current study, inactivation of the bacteria was expected to occur through contact. Several mechanisms by which silver can inactivate bacterial cells have been reported in literature; however, it is commonly known to damage the cell wall and membrane.

TEM micrographs showed that both S. enteriditis (FIG. 9b) and B. subtilis (FIG. 9e) formed cell ghosts after contact with the modified montmorillonite. Cell ghosts are empty cell envelopes (no cytoplasmic content) usually of Gram negative bacteria with cellular morphology intact. Contact of bacterial cells with the modified montmorillonite could have caused the leakage of K⁺ ions and the cytoplasmic contents of the cells resulting in the formation of cell ghosts. Although inactivation of both bacteria resulted in the formation of cell ghosts, the manner with which it occurred appeared to be different. The Gram negative S. enteriditis experienced separation of the cell membrane from the cell wall leading to the shrinkage of the cytoplasm (FIG. 9c). The Gram positive B. subtilis experienced wrinkling of the cell wall which could be associated with perforation of the cell wall and release of the cytoplasmic content and consequently cell deformation.

This invention, as illustrated, provides a layered silicate (such as montmorillonite, bentonite, beidellite, saponite and notronite) modified with an ion, e.g. silver(I), complex containing an N-alkyl heterocycle ligand, e.g. N-octylimidazole, which is a nanomaterial that possesses superior water disinfection efficacy for a broad spectrum of waterborne pathogenic bacteria, with the incorporated antimicrobial metal complex not leachable over a long period. Although not wishing to be bound by theory, the inventors believe that metal, e.g. silver, and imidazole derivatives may be acting in a synergistic manner during the disinfection process. The longer alkyl chain imparts hydrophobicity on the silver complex and thus advantageously increases the possibility for non-leachability of the complex. This nanomaterial has great potential to be used for the production of household (point-of-use) water disinfection devices and/or in water treatment facilities.

Use of nanoclays for water treatment is beneficial since they are naturally occurring materials with a low cost. They have large surface area-to-volume ratios which translate to high efficiencies.

We claim:

1. A layered silicate modified with a metal ion N-heterocyclic complex, the N-heterocyclic ligand of the metal ion N-heterocyclic complex being N-alkyl substituted or alkylated at positions 2-, 4- or 5- of the N-heterocyclic ring.

2. The modified layered silicate of claim 1, in which the metal ion is Ag⁺, Cu²⁺ or Zn²⁺.

3. The modified layered silicate of claim 1, in which the N-heterocyclic ligand is selected from the group consisting of imidazoles and triazoles.

4. The modified layered silicate of claim 1, in which substitution of the hydrogen atom on the nitrogen atom of the N-heterocyclic ligand is with a hydrophobic substituent.

5. The modified layered silicate of claim 1, in which substitution of the hydrogen atom on the nitrogen atom of the N-heterocyclic ligand is with an alkyl chain selected from the group consisting of octyl, decyl, dodecyl, tetradecyl and hexadecyl.

6. The modified layered silicate of claim 1, in which the layered silicate is a negatively charged layered silicate.

7. The modified layered silicate of claim 1, in which the layered silicate is selected from the group consisting of montmorillonite, bentonite, beidellite, saponite and notronite.

8. The modified layered silicate of claim 1, which is in particulate form and which has a particle size distribution such that it has a D90 value of no more than 500 μm, and a D10 value of at least 50 μm.

9. The modified layered silicate of claim 1, in which the quantity of metal ion N-heterocyclic complex in the modified layered silicate is at least 25% of the cation exchange capacity (CEC) of the layered silicate.

10. The modified layered silicate of claim 1, which includes metal nanoparticles capped by an N-alkyl substituted heterocyclic ligand.

11. The modified layered silicate of claim 10, in which the metal ion N-heterocyclic complex is intercalated in interlayer spaces of the modified layered silicate and in which the metal nanoparticles are not intercalated in the interlayer space of the modified layered silicate.

12. A method of treating water to disinfect the water, the method including contacting the water with a layered silicate modified with a metal ion N-heterocyclic complex, wherein the N-heterocyclic ligand of the metal ion N-heterocyclic complex is N-alkyl substituted or alkylated at positions 2-, 4- or 5- of the N-heterocyclic ring and wherein the metal ion has antimicrobial or disinfectant properties.

13. The method of claim 12, in which the modified layered silicate is a modified layered silicate according to any one of claims 2 to 11.

14. The method of claim 12, in which the water includes pathogenic Gram negative and/or Gram positive bacteria, the treatment disinfecting the water from said pathogenic Gram negative and/or Gram positive bacteria.

15. The method of claim 14, in which the water is disinfected from pathogenic Gram negative bacteria selected from the group consisting of Salmonella enteriditis, Shigella dysenteriae and Vibrio cholerae.

16. The method of claim 14, in which the water is disinfected from the pathogenic Gram positive bacteria Bacillus subtilis.
